(19) United States
(12) Patent Application Publication
(10) Pub. No.: US 2008/0284778 A1
(43) Pub. Date: Nov. 20, 2008

(54) Graphical Instrument Panel

(76) Inventors: Goran Borgesson, Skarhamn (SE); Henrik Bergstrom, Trollhattan (SE)

Correspondence Address: HARNESS, DICKEY & PIERCE, P.L.C., P.O. BOX 8910, RESTON, VA, 20195, US

(21) Appl. No.: 11/630,991

(22) PCT Filed: Jun. 30, 2005
(86) PCT No.: PCT/SE2005/001042

§ 371 Date: Apr. 15, 2008

(30) Foreign Application Priority Data
Jun. 30, 2004 (SE) 0401682-0

(51) Int. Cl. G06T 15/00

(52) U.S. Cl. 345/419

(57) ABSTRACT

A system for simulating an instrument panel in a wheeled vehicle, comprising: a vehicle interior with an image presentation surface placed on the location for the instrument panel (4); an image presentation means (6) devised to present an image on the image presentation surface; an image presentation computer (8) that is communicatively coupled to the image presentation means (6) and devised to control the presentation of an image on the image presentation surface, wherein a control computer (10) provided with a computer control program comprising computer program code that is configured to realise a graphics editor (12) with an input interface for compilation of a graphical representation (14) of an instrument panel; and wherein the control computer is communicatively coupled to the image presentation computer (8) for presentation of said graphical representation (14) of an instrument panel on the image presentation surface. formed by first removing the bulk of the material from portions of the back side of the workpiece without thinning the entire workpiece. The bulk removal process, for example, can form a first opening that extends to an intermediate depth within the workpiece, but does not extend to the contact surface of the electrically conductive element. After forming the first opening, a second opening is formed from the intermediate depth in the first opening to the contact surface of the conductive element. The second opening has a second width less than the first width of the first opening. This method further includes filling the blind vias with a conductive material and subsequently thinning the workpiece from the exterior side until the cavity is eliminated.

### TECHNICAL FIELD

The present invention relates to technology for simulating design and functions of instrument panels for vehicles.

### BACKGROUND

In the design of instrument panels for vehicles great importance is today given to safety and ergonomics. In order to be able to test a certain design test arrangements are made in driver environments. Traditional technology for building such a test arrangement in a three dimensional model with real instruments or models is time consuming and costly. This is particularly evident in evaluation and tests with many small changes and adjustments in the test arrangement. There is therefore a need for a more flexible technology for making test arrangements for instrument panels.

### STATE OF THE ART

In the state of the art there are examples of simulation technology for evaluating vehicle designs.

In the patent publication DE 101 18 397 A1 and corresponding GB 2 362 551 there is disclosed a system and a method for evaluating a vehicle design in a virtual environment. This piece of prior art is directed to represent a scalable digital representation of a human user in the same virtual environment as that of the vehicle.

In the patent publication WO 03/025511 there is disclosed technology for evaluation of the design of the instrumentation on an instrument panel. An image of an instrument panel is presented by means of projection on a transparent light screen on the usual place for the instrument panel in a vehicle simulator or in a real vehicle. A mask with recession and actuating means in the instrument panel are coordinated with the projected image. In connection with development of a new instrument panel design it is usually desirable to chose between different detailed designs of the parts of the instrument panel. The mentioned prior art WO 03/025511 indicates that the projected graphics without any problems can be changed through changes in software, but there is no guidance for how this should be done.

In fact the flexibility in changing the design of the instrument panel is itself crucial for the possibility to rationalize the interaction between design, testing and evaluation that is involved in the design work. There is therefore a need for improving the production and the presentation of the simulated instrument panel.

### OBJECT OF THE INVENTION

The object of the present invention and the technical problem to be solved by the invention is to achieve an improved simulation means for design and testing of an instrument panel in a vehicle. An aspect of the problem is to achieve means for handling graphics that represent an instrument panel.

### SUMMARY OF THE INVENTION

The invention is preferably applied in a simulator in which a vehicle interior is provided with an image presentation surface located on the place for the instrument panel. The image presentation surface can cover a part of the instrument panel or the whole space that in a vehicle is used for instruments, controls, glove compartment and the like. The image presentation surface can be a display screen or a focusing (ground-glass) screen for the projection of slides.

According to the invention the object is achieved by generating an image of an instrument panel with the aid of a computer by means of a computer control program that comprises an input interface with a graphics editor and simulation functionality for manipulating the image during presentation dependent on a predetermined scheme, or dependent on input signals and on predetermined rules. An image of an instrument panel is compiled by means of the graphics editor, wherein the image can be constituted by photographs, drawings or some other graphics. Changes in the instrument panel, e.g. deflections on a speedometer or indications from signal lamps, are presented by means of the mentioned simulation functionality.

A thus compiled image is presented on a presentation surface by means of an image presentation means that is communicatively coupled to the control program. A human user can then experience a graphic instrument panel in the vehicle interior. The graphical instrument panel can thus be manipulated and changed during testing by means of the graphics editor and the simulation functionality and immediately be represented on the image presentation surface. The image presentation means can comprise graphics circuits coupled to the mentioned computer that is coupled to a display screen on the image presentation surface, or to one or more slide projectors that are arranged to project an image on a focusing (ground-glass) screen at the image presentation surface.

In modern cars there are in addition to the traditional instrument panel often a number of support systems, for example a trip computer with associated functions, a navigation system and radio/music equipment. Such support systems are usually maneuvered by operating a menu and the design of such menus is important for functionality and safety in the driver environment. Embodiments of the invention are devised for operating and simulating such menus that may occur on the instrument panel or on separate instruments and presentation units.

In this way and by working with the graphical instrument panel in accordance with the invention, changes in shape or location of for example instruments and controls can be made immediately in connection with design and evaluation of an instrument panel.

Among other things, an advantage with the invention is that proposals for a design of an instrument panel can be compiled and presented in a realistic vehicle interior quickly, to low cost and in a simple way. Furthermore, the function of components in the instrument panel can be tested in relation to electronics and thereby enables early decisions about design and production of electronics. Computer programs for controlling parts of the instrument panel can also be more easily designed and enables the production of a better basis for orders to e.g. subcontractors.

### BRIEF DESCRIPTION OF THE DRAWINGS

The invention is described in more detail with reference to the accompanying drawings in which:

FIG. 1 shows a schematic outline of an embodiment of the system for simulating an instrument panel in a vehicle in accordance with the invention;

FIG. 2 shows a simulator system according to an embodiment of the invention.

### DETAILED DESCRIPTION OF EMBODIMENTS

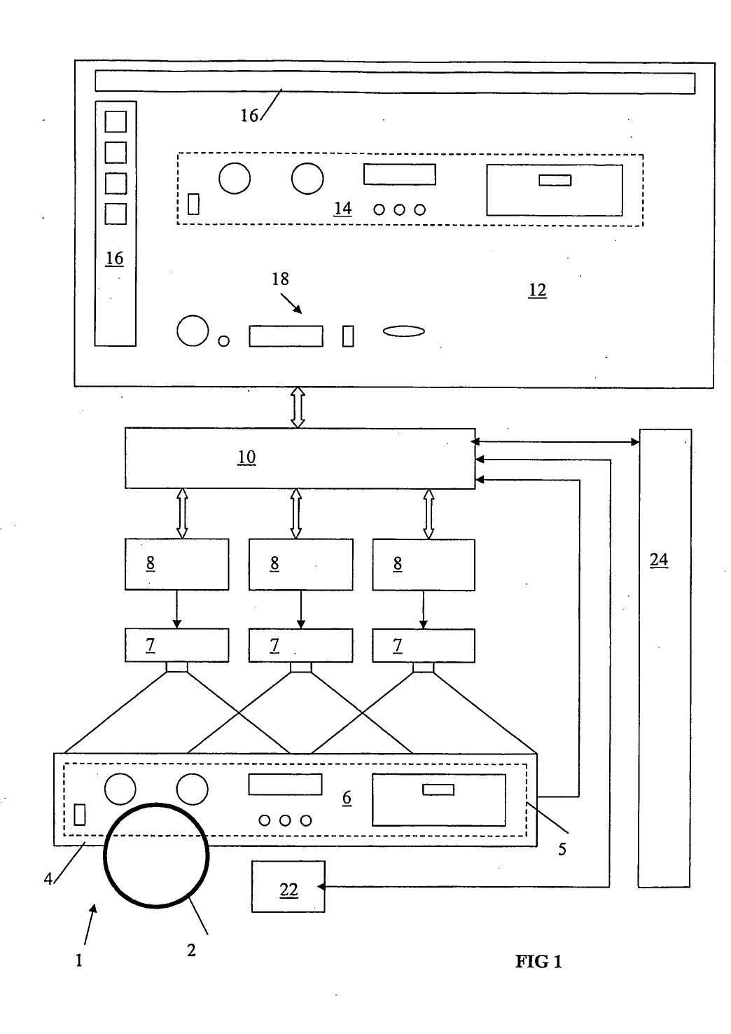

FIG. 1 shows a schematic outline of an embodiment of the system in accordance with the invention for simulating an instrument panel in a vehicle by means of a computer generated graphical instrument panel. Down in the lower part of FIG. 1 there is schematically shown a part of an interior 1 in a vehicle with a steering wheel 2 and an instrument panel 4. The instrument panel 4 is provided with an image presentation means 6 for example in the shape of a projection screen or a focusing (ground-glass) screen for the projection of slides, or in the shape of a computer display screen such as a CRT-screen or a flat LCD-screen. In one embodiment the mage presentation means 6 is provided with a touch sensitive surface constituting a touch screen 5. In another embodiment it is arranged that an input unit in the shape of a pointing device, for example a conventional computer mouse, is coupled such that different functions or controls that are projected on the image presentation means can be controlled by means of the pointing device and associated mouse buttons.

An image of an instrument panel is presented on the image presentation means 6 by means of an image generation means 7. In FIG. 1 there is shown an exemplifying embodiment where the image generation means comprises one or more digital slide projectors 7 that are arranged to project a digitally stored image on the image presentation means 6. In a practical implementation of this embodiment of the invention a car body can have its instrument panel substituted with a focusing (ground-glass) screen and slide projectors mounted under the bonnet at the ordinary location for the engine. This setup can by means of the invention be combined with separate image presentation means of some other type, e.g. in the shape of a display screen that simulates or constitutes a separate instrument.

The image generation means 7 is communicatively coupled to an image presentation computer 8 for controlling the presented image. In the case with more projectors, such as illustrated in FIG. 1, every projector 7 is preferably coupled to a separate computer 8. Other configurations are also possible. The image presentation computers 8 are communicatively coupled to a control computer 10 that coordinates the image presentation computers 8 and the presented images by means of a server function. A plurality of clients are arranged to control the presentation of their own parts of an image presentation. This can, as in this example, be a plurality of separate images that are coordinated by the control computer 10 to together present a larger full picture. In another embodiment, the control computer can coordinate the presentation of separate images on different instruments or instrument panels. For example, a traditional instrument panel can be coordinated with the presentation of a menu system on a separate presentation unit that e.g. simulates navigation equipment or radio/music equipment. The client/server architecture is advantageous also in practical use when instruments are presented and simulated in a car interior via a plurality of image presentation means, projectors and/or display screens. During evaluation of the simulated instrumentation it is an advantage to have the server computer or the server functionality in e.g. a portable computer and to coordinate the clients from there. In the evaluation it is then possible to sit in the simulation interior and to directly manipulate the simulated instrumentation via the server computer.

The control computer 10 comprises program code that is devised to realise a graphics editor provided with an input interface 12 for the compilation of a graphical representation 14 of an instrument panel, hereinafter called a graphical instrument panel. The graphics editor 12 comprises functions with editing tools and command fields for the execution of such tools, for example for the realisation of rotation, positioning, scaling, visible/invisible (turn on/turn off) and suchlike functions. In the graphics editor, graphical objects 18 that are used as components in the compilation the graphical representation 14 of an instrument panel can be created, imported and stored. The graphical objects can for example be digital photos, digitalised drawings, computer generated images, movies, sound etc, and be constituted by external computer programs that realises a graphical object or behaviour in the shape of input or output from a simulated instrument. Menu systems are for example realised by means of Excel programs that can be created separately and then be imported from the control program of the control computer 10.

In order to simulate behaviour of real instrument panel components the control computer 10 further comprises program code in the shape of control program that is devised to operate and control changes in the graphical objects that preferably are presented in relation to a background that is a representation of a car interior. The mentioned control programs are for example devised to change the appearance of graphical instrument panel components dependent on input data, input signals or according to a predetermined scheme, for example a deflecting speedometer. Such control programs are realised preferably as separate processes or control programs that are executed within the framework of the control program of the control computer 10 or is called from the mentioned control program.

Real, i.e. physical components 22, such as controls or equipment in the car are in one embodiment communicatively coupled to the control computer 10 and the control program. Output signals from such real components can thereby be read into the control program and be used to generate an influence on a graphical component in the simulated instrument panel. Suitable I/O units such as A/D converters and the like are arranged between input components and the control computer.

A system for the simulation of an environment 24 is preferably communicatively coupled to the control computer 10. This system typically comprises an image presentation unit with a display screen for presentation of a driving environment. A control system for the simulation of an environment is preferably devised to simulate effects of different gear positions in the car, speed, engine rotation speed and other vehicle data, light conditions such as day, night, twilight etc, and to cooperate in selected parts with the control computer for controlling the instrument panel functions.

In an embodiment where the instrument panel surface is provided with a touch screen, the control computer is communicatively coupled to the touch screen. A graphical instrument panel component can thereby be coupled to a defined surface segment or defined coordinates on the surface that deliver an input signal to the control program when touched.

During evaluation and design it is possible to experience appearance, location and function of the instrument panel and its parts in the vehicle interior according to the invention. Real, physical components can also be mixed with graphical components and the interaction between them be simulated.

In order to enhance the realistic experience in the simulation an embodiment of the invention is devised such that a 3-dimensional (3D) image is generated and presented on the image presentation means. In one embodiment the 3D graphics is realised by presenting images having a green and a red colour, respectively, and that are superimposed in a displaced position relation to each other. These superimposed images are watched by an observer through traditional stereographic 3D glasses with one red and one green filter. It is also conceivable to realise 3D reproduction by superimposing paced images, but in general stereographic 3D glasses are better to use together with real controls.

In use the system in accordance with the invention operates such that an instrument panel is compiled in the graphics editor by importing and possibly manipulating images and backgrounds, and by importing external programs for the control of functional processes. In simulation the control computer 10 coordinates a number of clients that are connected in a network and that are arranged to present their respective parts of instrument panel images and simulated functions.

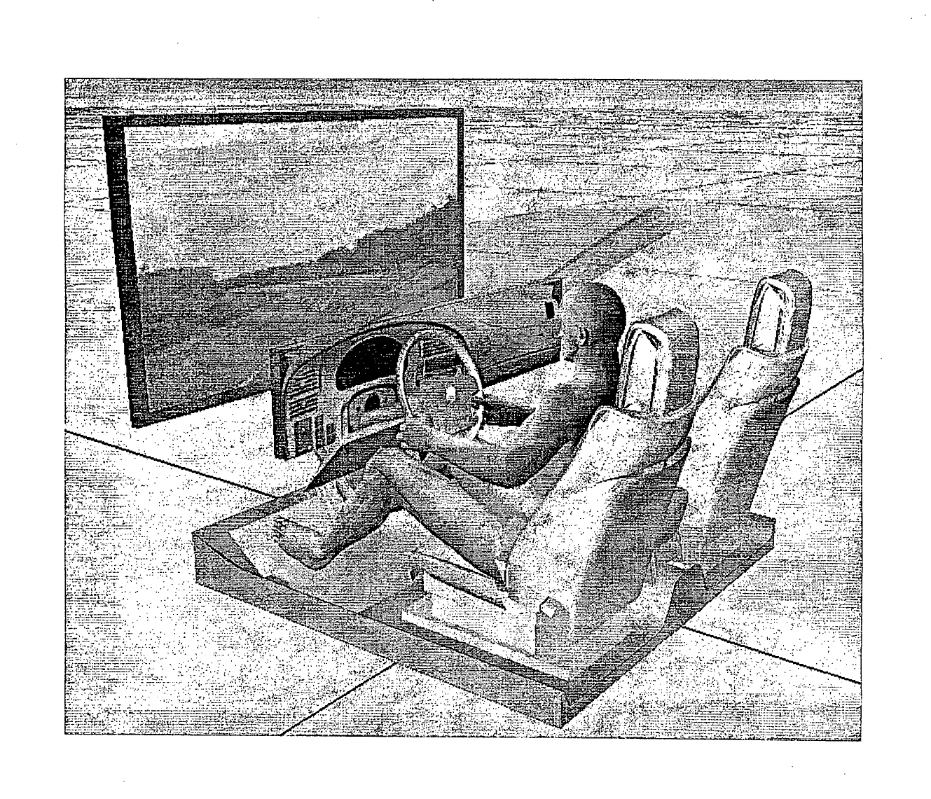

FIG. 2 shows a simulator for simulating a vehicle interior of a wheeled vehicle, comprising:
a driver environment with a seat and selected driver controls;
a driver environment with an image presentation surface placed on the location for the instrument panel;
an image presentation means devised to present an image on the image presentation surface;
an image generation unit that is devised to generate an image of an instrument panel and that is communicatively coupled to the image presentation means. The simulator further comprises an image presentation means devised for presentation of a simulated driving environment. Such a simulator is independent of a physical car body with a driver interior and can easily be folded up and transported.

1. A system for simulating an instrument panel in a wheeled vehicle, comprising:
a vehicle interior with an image presentation surface placed on the location for the instrument panel;
an image presentation means devised to present an image on the image presentation surface;
an image presentation computer that is communicatively coupled to image presentation means and devised to control the presentation of an image on the image presentation surface,
wherein
a control computer provided with a computer control program comprising computer program code that is configured to realise a graphics editor with an input interface for compilation of a graphical representation of an instrument panel; and in
that the control computer is communicatively coupled to the image presentation computer for presentation of said graphical representation of an instrument panel on the image presentation surface.

2. The system of claim 1, wherein the graphics editor is devised to create, import and store graphical objects that is used as components in the compilation of a graphical representation of an instrument panel.

3. The system of claim 2, wherein the control computer control programs with computer program code that is configured to operate and control changes in said graphical objects.

4. The system of claim 3, wherein the computer control program comprises computer program code that is configured to realise a simulation functionality for manipulating the image during presentation.

5. The system of claim 4, wherein the computer control program comprises computer program code that is configured to realise said simulation functionality for manipulating the image during presentation dependent on a predetermined scheme.

6. The system of claim 4, wherein the computer control program comprises computer program code that is configured to realise said simulation functionality for manipulating the image during presentation dependent on input signals.

7. The system of claim 4, wherein the computer control program comprises computer program code that is configured to realise said simulation functionality for manipulating the image during presentation dependent on predetermined rules.

8. The system of claim 4, wherein the computer control program comprises computer program code that is configured to realise said simulation functionality for manipulating the image during presentation dependent on input data.

9. The system of claim 3, wherein said control programs are devised to change the appearance of graphical instrument panel components and are realised by means of separate programs devised for controlling function processes.

10. The system of claim 2, wherein the graphics editor are devised with functions for editing tools and command fields for the execution of such tools.

11. The system of claim 1, wherein the control computer is devised with a server function devised to coordinate a plurality of image presentation computers and a plurality of presented images.

12. The system of claim 1, wherein the control computer is devised to coordinate, during presentation and simulation of a graphical representation of an instrument panel, a plurality of clients in a client/server architecture that are connected in a network that are devised to present their respective parts of instrument panel images and simulated functions.

13. The system of claim 1, wherein the image presentation means is a slide projection screen, preferably in the shape of a focusing (ground-glass) screen devised for slide projection.

14. The system of claim 12, wherein an image generation means in the shape of a slide projector with a digitally controllable image display devised for the projection of a slide image on the projection screen of the image presentation means.

15. The system of claim 1, wherein the image presentation means is a computer screen unit.

16. The system of claim 1, wherein the image presentation means is provided with an image is provided with a touch sensitive surface constituting a touch screen that is communicatively coupled to the control computer.

17. The system of claim 15, wherein it is devised that a graphic instrument panel component is coupled to a defined surface segment or defined coordinates on the surface that when touched deliver an input signal to the control program.

18. The system of claim 1, wherein there is devised an input unit in the shape of a pointing device that is coupled for controlling functions or control devices that are projected on the image presentation means.

19. The system of claim 18, wherein said pointing device is a conventional computer mouse.

20. The system of claim 1, further devised such that a 3-dimensional image of an instrument panel is generated and presented on the image presentation means.

21. The system of claim 1, wherein a system for environment simulation comprising an image presentation means devised for the presentation of a simulated driving environment is communicatively coupled to the control computer and devised to cooperate with the control computer for controlling the instrument panel functions.

22. The system of claim 21, comprising a structure devised for setting up driver environment with a seat and selected driver controls.

23. A computer program product for simulating an instrument panel for a vehicle, comprising computer program code for controlling a data processing unit to perform steps and functions according to claim 1.
